(19) United States
(12) Patent Application Publication
(10) Pub. No.: US 2016/0090784 A1
(43) Pub. Date: Mar. 31, 2016

(54) ADJUSTABLE MULTIPURPOSE LADDER ACCESSORIES

(71) Applicant: Christopher Hager, Roanoke, VA (US)

(72) Inventor: Christopher Hager, Roanoke, VA (US)

(21) Appl. No.: 14/502,541

(22) Filed: Sep. 30, 2014

(51) Int. Cl. E06C 7/14

(52) U.S. Cl. CPC E06C 7/14

(57) ABSTRACT

Systems and articles of manufacture for use as adjustable multipurpose ladder accessories are described. A particularly advantageous component of the system is a frame rail bracket that is configured to wrap around three sides and at least a portion of a fourth side of a side rail of a ladder and securely fit to it through a tightening mechanism. The frame rail bracket can be secured at any position on the ladder by sliding along the side rail without interacting with the ladder rungs. Additional components include a top support member and bottom support member which are operably connected to the frame rail bracket. The top support member and bottom support member have 360° of rotation on an axis perpendicular to the frame rail bracket, providing additional positioning options. The top support member and bottom support member cooperate to hold elongated items and make them available to a contractor, providing safe material handling.

### BACKGROUND OF THE INVENTION

1. Field of the Invention

The present invention relates to adjustable multipurpose ladder accessories. More particularly, the present invention relates to ladder accessories that secure to the side rails of a ladder at any position without interacting with the ladder rungs and have 360° of angular rotation.

2. Description of Related Art

A long-standing problem for workers in the construction trades is handling materials safely while up on a ladder, and to date, this problem has not been adequately addressed. Various ladder accessories which are designed to hold a range of items have been developed to address this. Examples of efforts in this area include those described in U.S. Pat. Nos. 6,009,976; 5,542,553; 5,106,045; 5,855,346; 6,105,911; 3979,097; 4,949,925; and 4,964,601, each of which is incorporated by reference herein in its entirety. However, many of the devices in the prior art have parts that engage or interfere with the ladder rungs, which limits the ability to position these devices on the ladder. Further, many of these devices are limited to a fixed angular position relative to the ladder or the ground. Thus, there is a need for improved devices that overcome these limitations.

### SUMMARY OF THE INVENTION

Embodiments of the present invention provide systems and articles of manufacture for use as multipurpose ladder accessories with a potentially wide range of positioning. In one embodiment, the present invention provides a system for securing items to a ladder and making them available to a user, such as a contractor or builder while allowing the user free use of their hands.

In a particular aspect of the invention, provided is a system for securing articles to a ladder, the system comprising: at least two article support member and frame rail bracket pairs; wherein each frame rail bracket is configured for slideable engagement with a side rail of a ladder without contact with a rung of the ladder; wherein each frame rail bracket has a tightening mechanism configured to provide pressure between the frame rail bracket and the side rail of the ladder to fix the frame rail bracket at any of a number of positions on the ladder; and wherein each article support member is in operable communication with one of the frame rail brackets by way of a fastener that provides an axis of rotation for the article support member to rotate from 0° to 360°. In embodiments, the fastener is a bolt and wing nut assembly.

In other particular embodiments, at least one of the article support members is configured as an open box or bucket and at least one of the article support members is configured as a four-sided collar.

While embodiments of the system may be capable of securing items/articles of a range of sizes, a particular advantageous embodiment allows for elongated items such as siding, plywood, fascia boards, rake boards, metal trim, J-channel, and similar construction materials, to be secured next to a ladder in safe reaching distance. This enhances material handling safety while on the ladder, as well as safety of persons on the ground. Systems and articles of manufacture of the invention may be useful as accessories for any type of ladder, including step ladders, straight ladders, extension ladders, platform ladders, telescoping ladders, folding ladders, and multipurpose ladders.

Components of embodiments of the system include two or more frame rail brackets. Each frame rail bracket is configured to wrap around either side rail (left or right) of a ladder. In an exemplary embodiment, each frame rail bracket is configured to wrap around three sides of a side rail and a portion of a fourth side. Further, each frame rail bracket has a tightening mechanism capable of producing pressure between the side rail and the bracket, and each frame rail bracket is capable of sliding lengthwise along the side rail without interfering with the ladder rungs when repositioned during use.

Additional components of embodiments of the system may include a bottom support member and a top support member. The bottom support member may be configured to support the weight of one or more elongated articles, while the top support member may be configured to hold the sides of the one or more elongated articles such that the articles remain vertical, or held in a desired position, such as at about parallel to the sides of the ladder. In embodiments, the bottom support member is an open box and the top support member is a collar. In embodiments, the open box and collar may be joined to the frame rail bracket through a brace and a fastener.

In embodiments, the bottom support member and top support member are each operably connected to one of the frame rail brackets such that they each form a bottom unit and top unit of the system. By virtue of the frame rail brackets, the top unit and bottom unit may be secured to a side of a ladder at any position and at any angle and further adjusted up or down the side of the ladder at any position. For example, the top and bottom support members may be positioned such that their length and width are parallel to the ground, so that the side walls are perpendicular to the ground, regardless of the position of the ladder relative to the ground, or other support surface on which the ladder is placed. This configuration allows ideal positioning of elongated items held by the top and bottom units so that they are held vertical relative to the ground. Both units may be positioned in such a configuration even though the ladder itself is disposed at an angle relative to the vertical wall it rests on. However, in some applications, it may be desirable to position the top or bottom unit or both at an angle relative to the ground or the ladder when mounted on a ladder during use, and embodiments of the system of the invention allow for this positioning. Embodiments of the system of the invention allow the top support member or bottom support member to be positioned along their longitudinal axis at a full range of angles relative to the ladder or the ground, including anywhere from 0° to 20°, 0° to 45°, and 0° to 90°, 0° to 135°, 0° to 180°, 0° to 225°, 0° to 270°, 0° to 315°, and 0° to 360°; such angles may be determined relative to the width of the top support member and bottom support member and the plane of the ground or the length of the side rail of the ladder. Additional flexibility in positioning provided by systems of the invention includes the ability to secure elongated items of a range of sizes and shapes, the ability to adjust the position of the top and bottom unit by sliding each along the side rails as one advances upward or downward along the ladder, and the ability to attach the top and bottom unit from the ground or while standing on the ladder.

Embodiments of the system of the invention include variations in which only the bottom unit is used. For example, an open box embodiment of the bottom support member may be used to hold screws, drills, wrenches and other tools to aid in the installation of windows and shutters. Alternatively, when inverted (rotated 180°), the base of the box can be used to support cans of paint, rollers, and brushes to assist in application of paint. Since the bottom support member has 360° of rotation, such configurations are possible. Conceivably, both the bottom and top unit may have other applications, including acting as a brace or support against a structure to provide stability to a ladder.

Additional embodiments of the invention include an article of manufacture in the form of a frame rail bracket as described herein. The frame rail bracket may have a variety of applications in securing items to a ladder or for securing a ladder to a fixture such as for stabilization purposes. Additional embodiments of the invention and their advantages will be set forth in the foregoing detailed description.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a schematic diagram showing a frame rail bracket according to an embodiment of the invention.

FIG. 2 is a schematic diagram showing a bottom support member according to an embodiment of the invention.

FIG. 3 is a schematic diagram showing a top support member according to an embodiment of the invention.

FIGS. 4-7 are photographs showing different perspective views of a top support member operably connected to a frame rail bracket, forming a top unit according to an embodiment of the invention.

FIGS. 8-11 are photographs showing different perspective views of a bottom support member operably connected to a frame rail bracket, forming a bottom unit according to an embodiment of the invention.

FIG. 12 is a photograph showing the top unit and bottom unit mounted on a side rail of a ladder according to an embodiment of the invention.

FIG. 13 is a photograph showing the top unit and bottom unit of FIG. 12 during use, such that the top unit and bottom unit cooperate to hold elongated items according to an embodiment of the invention.

FIG. 14 is a photograph showing that the top unit and bottom unit allow a ladder to be placed between two rafters with little pitch when each unit is attached to a ladder and placed on a side and rests on the top chord of a rafter.

FIG. 15 is a photograph showing a close-up view of the ladder of FIG. 14.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

Embodiments of the invention provide for systems and articles of manufacture which serve as adjustable multipurpose ladder accessories. One of the many advantages of the systems of the invention, only some of which are discussed herein, is that the multipurpose ladder accessories are capable of flexible positioning with respect to the point of attachment along the side rails of the ladder as well as their angle relative to the ladder or the ground. Providing these advantages in part are one or more frame rail brackets. In embodiments, the frame rail brackets have a portion that bends downward at 90° and another portion that bends inward at 90°, and with these portions the frame rail bracket is configured to wrap around three sides and a portion or all of a fourth side of a side rail of a ladder to provide for a secure fit. Completing the functionality of the frame rail bracket is a tightening mechanism that is capable of producing pressure between the side rail and the bracket. In embodiments, the tightening mechanism is a thumb screw or other type of fastener, or a spring (or a combination of these) which exerts pressure on the side rail and presses it toward the inward-bending portions of the frame rail bracket, thus providing for a secure fit between the side rail and the bracket during use. The frame rail bracket is capable of being positioned on the side rail simply by loosening the tightening mechanism and sliding the bracket upward or downward lengthwise along the side rail. When the bracket is moved to a desired position, it may then be fixed to the side rail through the tightening mechanism.

Embodiments of the system further provide a bottom support member and a top support member which together are configured to hold one or more elongated articles. The bottom support member, which in embodiments may be an open box- or bucket-shape, is configured to hold the weight of the elongated articles and the top support member is configured to secure the sides of the articles such that the articles remain vertical, such as in a position readily available for use and accessible to the user of the ladder. In embodiments, the top support member and bottom support member are each operably joined to a frame rail bracket through a brace on the frame rail bracket and one or more fasteners. When joined to a frame rail bracket, the top support member and bottom support member may each form a top and bottom unit capable of attachment to a ladder. In an exemplary embodiment, the top support member and bottom support member are rectangular-shaped, and are each connected to the frame rail bracket on their respective shorter side. When operably joined to the frame rail bracket, such a configuration allows the top support member and bottom support member to be capable of 360° rotation along their longitudinal axis relative to the length of the frame rail bracket. Such rotation allows the top support member and bottom support member to be positioned at any angle relative to the side rail of a ladder or the ground.

The top support member and bottom support member may take a variety of shapes and configurations. For the top support member, embodiments include a collar shaped as a circle, oval, triangle, square, rectangle, hexagon, or other polygon. For the bottom support member, embodiments include an open box or bucket with a circular or polygonal shape. Additionally the bottom support member may comprise a top open box or bucket and a bottom platform of wider dimensions which provides a ledge or platform for the bottom support member. The top support member and bottom support member may be custom-shaped to accommodate construction materials of a variety of shapes and sizes. The top and bottom support members may be configured to hold siding, plywood, fascia boards, rake boards, metal trim, gutters, J-channel and similar construction materials. When operably joined to the frame rail bracket, the bottom support member and top support member respectively form a bottom and top unit ready to be attached to ladder to provide flexible positioning and angular adjustment. Other embodiments may include an additional support member with a configuration similar to the top support member, which may be operably joined to a frame rail bracket to form a middle unit. The middle unit may be placed between the top unit and bottom unit to support the middle of elongated items. The top and bottom unit and optionally middle unit may be configured to attach to any type of ladder, including step ladders, straight ladders, extension ladders, platform ladders, telescoping ladders, folding ladders, and multipurpose ladders. Such configuration may be provided through modification of the dimensions of the frame rail bracket, or through other modifications which will be apparent to a skilled artisan. Still further, a system can comprise two support members configured as bottom support members, where one of the “bottom” support members is inverted and used instead of a top support member, or at a position above the other bottom support member and in addition to a top support member, which is used between the two units. Thus, as exemplified by this embodiment, he terminology “bottom” and “top” as used in this specification is intended only as a convenience and should not be construed as limiting the invention. Either the bottom or top support members can be used in a bottom, top, or intermediate position relative to any other bottom or top support member used in a particular system of the invention.

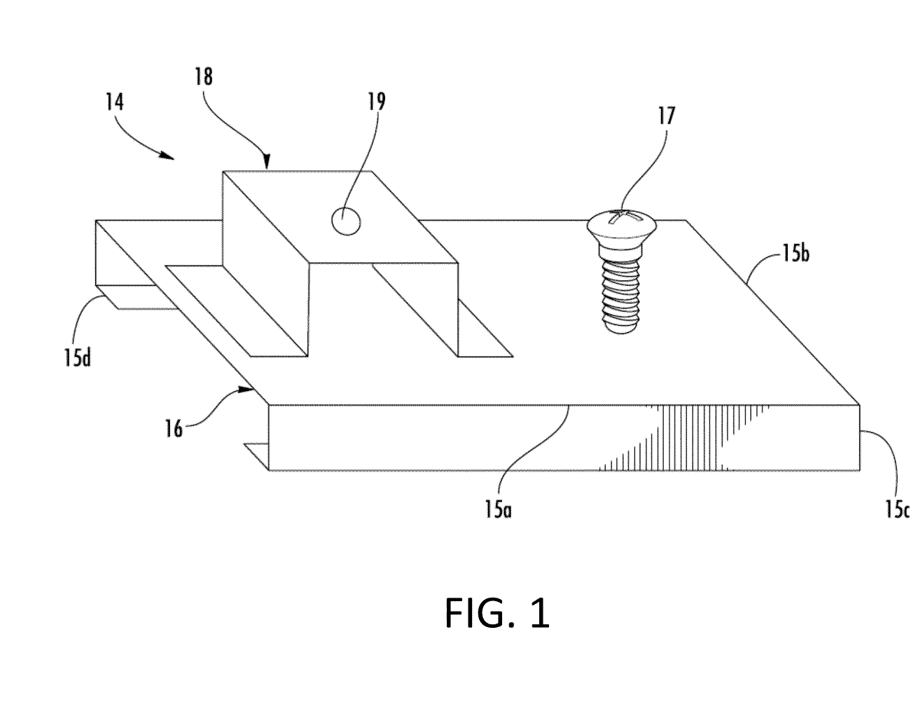

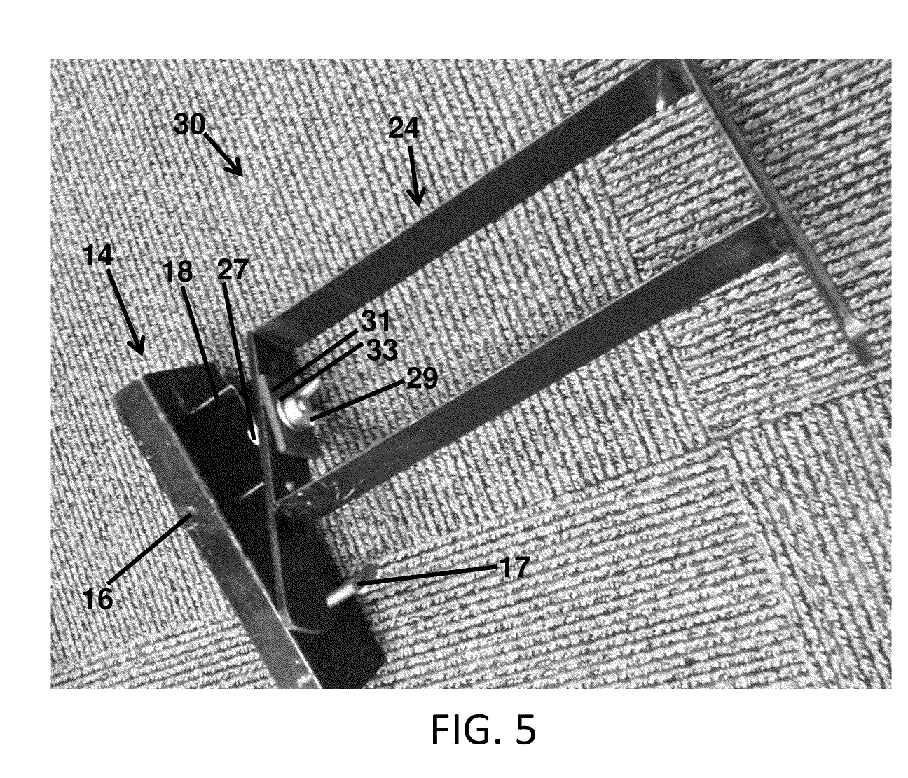

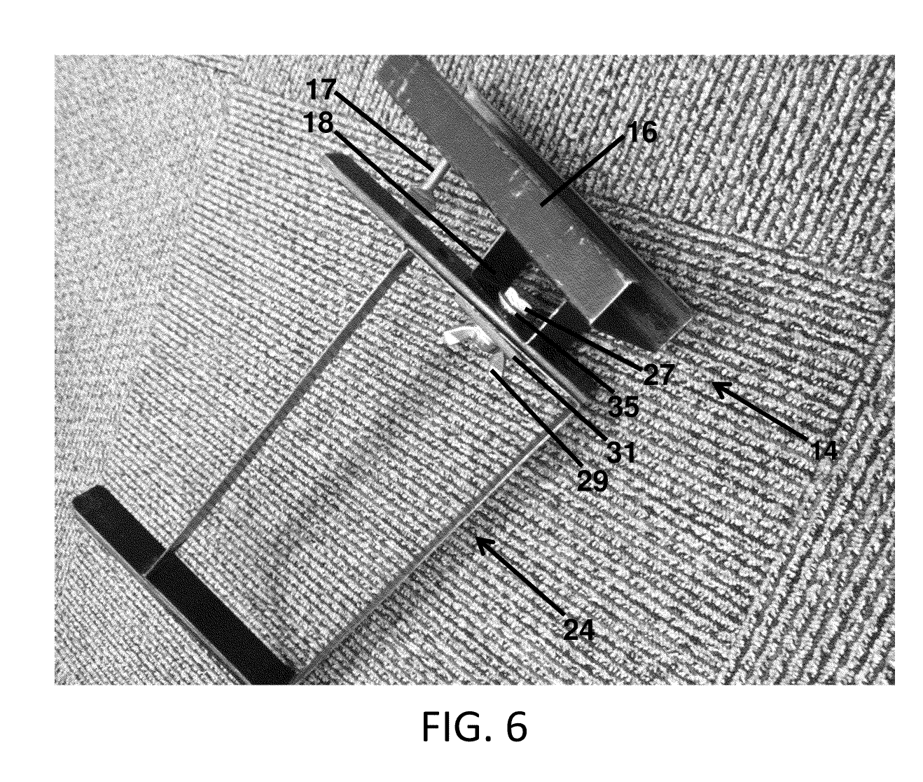

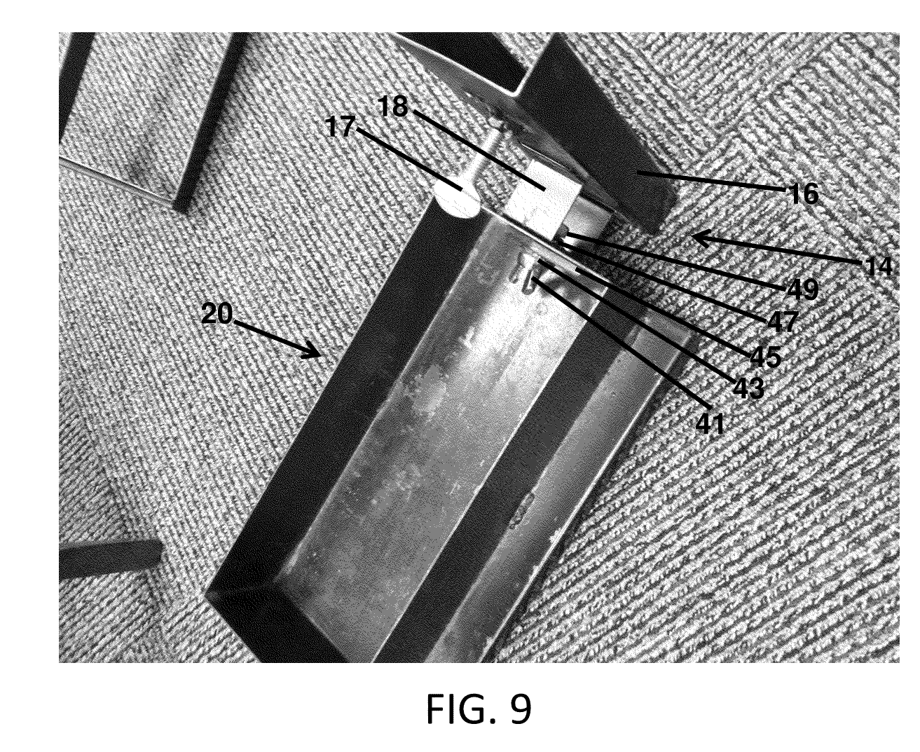

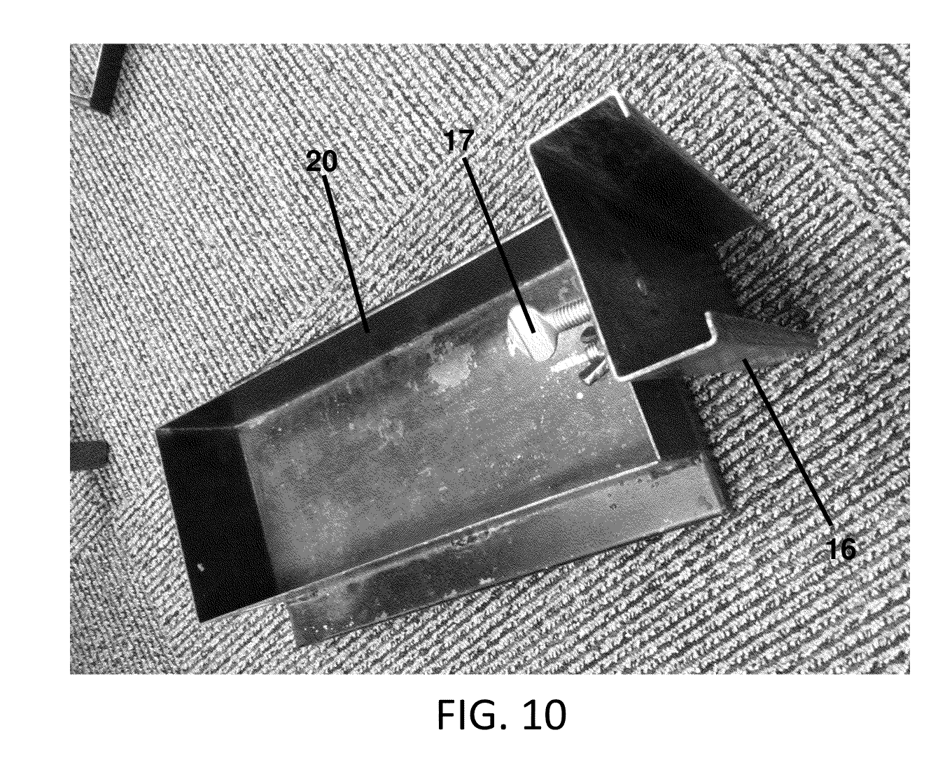

Referring now to the figures, FIGS. 1-13 show embodiments of systems and articles of manufacture of the invention. FIG. 1 shows an embodiment of a frame rail bracket 14, which includes an inward-bending piece of material 16 and U-shaped brace 18 for joining the frame rail bracket to other parts of the system. The U-shaped brace 18 includes connecting hole 19 for securing the frame rail bracket to a bottom support member or a top support member. Inward-bending piece of material 16 is used in combination with a tightening mechanism 17 which may be a lock-down thumb screw as depicted or a spring or a combination of these.

The inward-bending piece of material 16 is provided in dimensions which allow it to be secured to the side rails of a ladder. In embodiments, the inward-bending piece of material may be manufactured by bending a piece of sheet metal into the desired configuration. As a non-limiting example, the dimensions of the inward-bending piece of material are shown in FIG. 1, which may have a main planar face with a length 15a of about 10 inches and a width 15b of about 3 inches. The inward-bending piece 16 has a first and second primary flange (each with a planar face disposed at 90° from the main planar face) which may have a length 15c of about 1⅛ inches. The inward-bending piece of material 16 has a first and second secondary flange. The first secondary flange has a planar face disposed at 90° from the planar face of the first primary flange and the second secondary flange has a planar face disposed at 90° from the planar face of the second primary flange. The secondary flanges may have a length 15d of about 1⅜ inches. However, variations are possible, depending on the particular dimensions of the side rails of the ladder which one intends the frame rail bracket 14 to fit. Indeed, in embodiments of the invention, the inward-bending piece 16 is advantageously configured to wrap around three sides and a portion of a fourth side of either side rail (left or right) of a ladder, and the tightening mechanism 17 is configured to press the secondary flanges against the side rail of the ladder during use. However, frame rail brackets do not interfere or intrude with the climbing surface of the ladder since the inward-bending piece of material is limited to covering the side rail. In an exemplary embodiment the frame rail bracket has no hooks, clips, springs, extensions, flanges, or other parts which would interfere with the ladder rungs when the bracket is moved lengthwise up or down the ladder side rail during positioning of the frame rail bracket on the ladder. These features have the benefit of allowing the frame rail bracket to be placed at any position along the side rail(s) of a ladder.

In other embodiments, the dimensions of the inward-bending piece 16 and the planar members comprising the frame rail bracket may be 10-25%, 10-50%, 10-100%, or 10-200% lesser or greater than those provided above. Embodiments of the inward-bending piece may include dimensions with a length 15a of about 5 to 20 inches, width 15b of about 2 to 8 inches, and lengths 15c and 15d of ¾ inches to 2 inches. For example, the planar members (main face, primary flanges, and/or secondary flanges) may include dimensions with a length 15a of about 8-15 inches, width 15b of about 3 to 6 inches, and lengths 15c and 15d of 1 inch to 1.5 inches. Further, for example, the planar members (main face, primary flanges, and/or secondary flanges) may include dimensions with a length 15a of about 10-12 inches, width 15b of about 4-6 inches, and lengths 15c and 15d of 1¼ inches. These dimensions may vary depending on the type of ladder one wishes to fit the frame rail bracket to.

Additionally, in addition to serving as a component of the system of the invention, the frame rail bracket 14 may be useful as a stand-alone article of manufacture by virtue of its benefits in securing to a side rail of a ladder at any position while having a brace which allows it to be attached to other items. The frame rail bracket 14 may have a variety of applications as an accessory for a ladder related to securing items to a ladder or securing a ladder for increased stability. For example, two of the frame rail brackets 14 may be each attached to a weight and attached to a ladder at the base on opposite side rails to provide increased stability. Alternatively, two frame rail brackets 14 may be positioned to the top of the ladder on either side and used to secure the top of the ladder to the side of a structure through the use of hooks or latches. These are merely examples and a skilled artisan will find other uses and applications with the benefit of this disclosure.

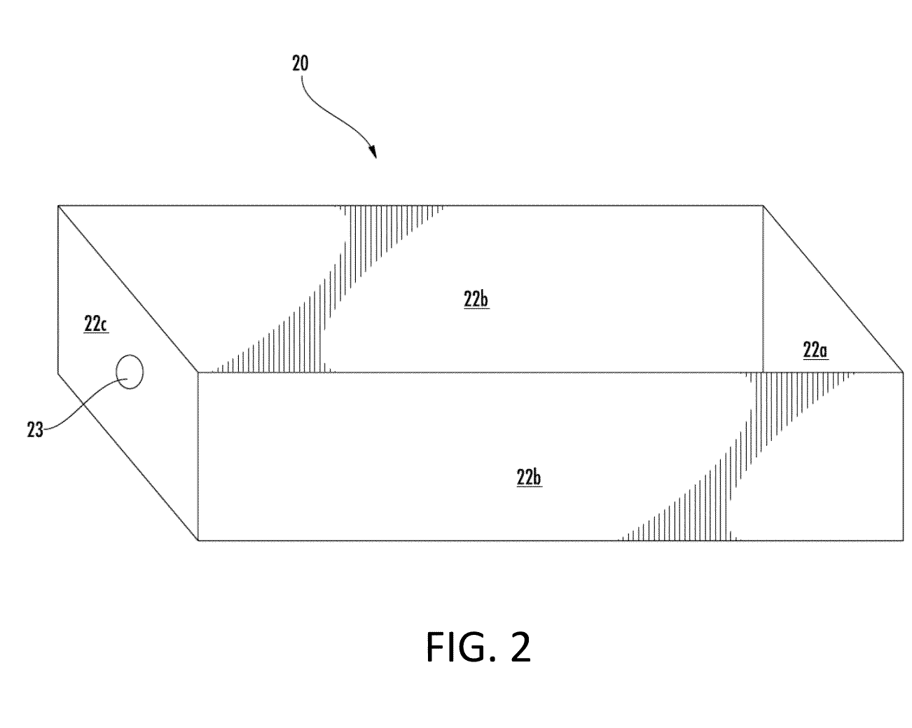

FIG. 2 shows an embodiment of a bottom support member 20 for use in a system of the invention. The bottom support member 20 may be made up of multiple rectangular pieces of material, including two short sides 22a and 22c and two long sides 22b. The shape of the bottom support member, however, is not critical and any shape can be used, including an overall square shape. One of the short sides 22c includes a hole 23 (otherwise referred to as a bracket injecting hole). Not shown is bottom portion of bottom support member, which completes a box for supporting the weight of items. Exemplary dimensions of the bottom support member may be 13 inches long by 5¼ inches wide by 3 inches deep. However, in other embodiments, the dimensions may be 10-25%, 10-50%, 10-100%, 10-200%, or 10-500% lesser or greater than these dimensions, depending on the type of material which one intends to hold. For example, for lighter materials, deeper dimensions may be desired to keep the materials secure from the wind. Embodiments of the bottom support member may include a length of 8 to 20 inches, a width of 3 to 10 inches, and a depth of 1 inch to 12 inches. For example, the bottom support member may include a length of 10 to 18 inches, a width of 5 to 9 inches, and a depth of 4 to 10 inches. Further, for example, the bottom support member may include a length of 12 to 15 inches, a width of 6 to 8 inches, and a depth of 6 to 8 inches.

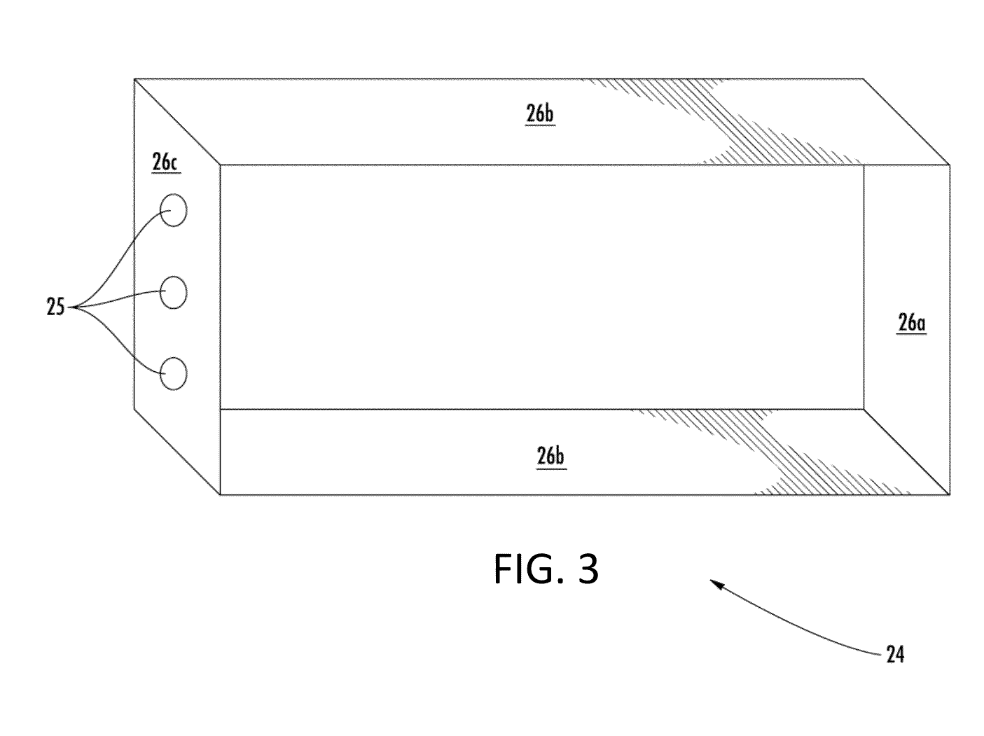

FIG. 3 shows an embodiment of a top support member 24 for use in a system of the invention. The top support member 24 may be made up of four elongated pieces of material, including two short sides 26a and 26c and two long sides 26b. One of the short sides 26c may have one or more adjustment holes 25. Exemplary dimensions of the bottom support member may be 13 inches long by 5¼ inches wide by 1½ inches deep. However, in other embodiments, the dimensions may be 10-25%, 10-50%, 10-100%. 10-200%, or 10-500% lesser or greater than these dimensions, depending on the type of material which one intends to hold. For example, for wider materials such as plywood, a greater length and width may be desired, while thinner materials such as trim or J-channel may require narrower dimensions. Thus, both the bottom support member and top support member may be custom-fit for particular applications. Embodiments of the top support member may include a length of 8 to 20 inches, a width of 3 to 10 inches, and a depth of 0.5 inch to 6 inches. For example, the top support member may include a length of 10 to 18 inches, a width of 5 to 9 inches, and a depth of 1 to 5 inches. Further, for example, the top support member may include a length of 12 to 16 inches, a width of 6 to 8 inches, and a depth of 2 to 4 inches.

As shown in FIGS. 1-3, embodiments of connecting hole 19, bracket injecting hole 23, and adjustment holes 25 may be ½ inch in diameter, plus or minus ¼ inch, and sized according to the type of fastener desired.

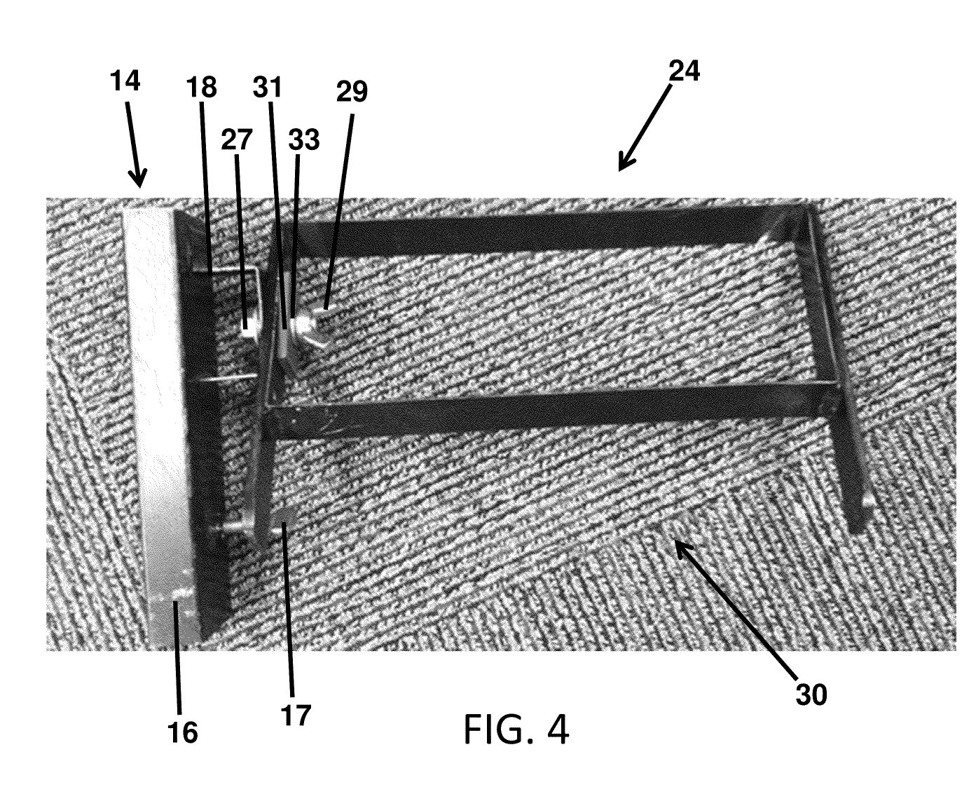

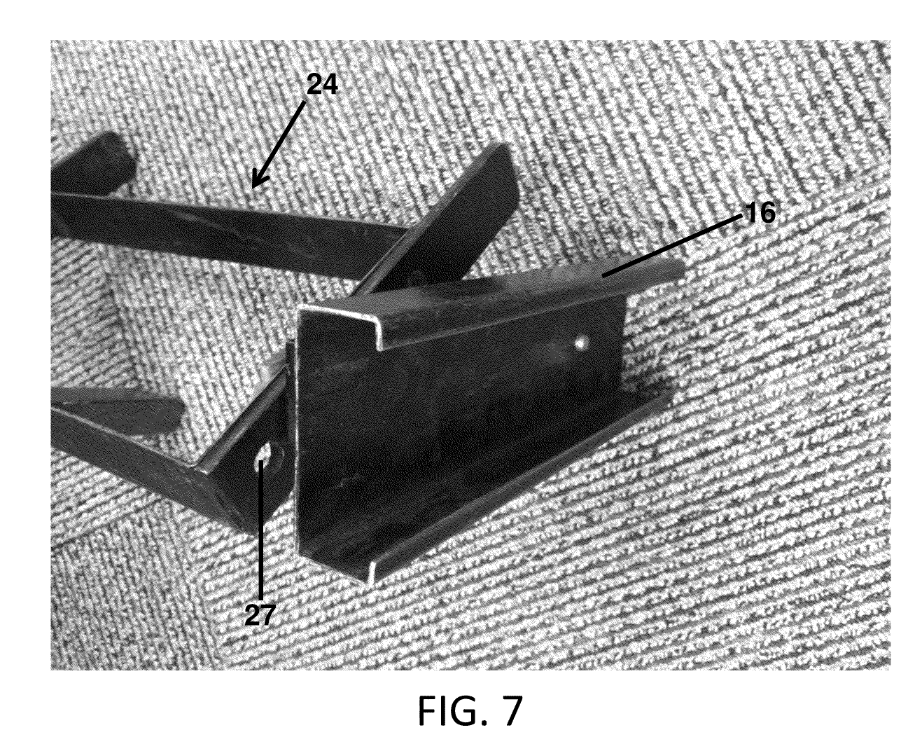

FIGS. 4-7 show an embodiment where frame rail bracket 14 is attached to a top support member 24 to form a top unit 30 of the system. Frame rail bracket 14 is attached to top support member 24 by bolt 27 which passes through holes 19 and 25. Bolt 27 is secured by wing nut 29. Support plate 31 and washer 33 intervene between wing nut 29 and side of support member 24. Additionally, frame rail bracket 14 has washer 35 between bolt 27 and side of brace 16. Additionally, FIGS. 4-7 show that top support member 24 may be adjusted at an angle relative to frame rail bracket 14 by virtue of bolt 27 and wind nut 29 assembly. The ability to adjust top support member 24 at an angle relative to frame rail bracket 14 provides versatility in securing the sides of elongated items. Further, FIG. 7 shows that top support member 24 has multiple adjustment holes 25 which allow for the frame rail bracket 14 to be attached at multiple positions. This provides additional versatility in adjusting systems of the invention to position the components to fit particular applications.

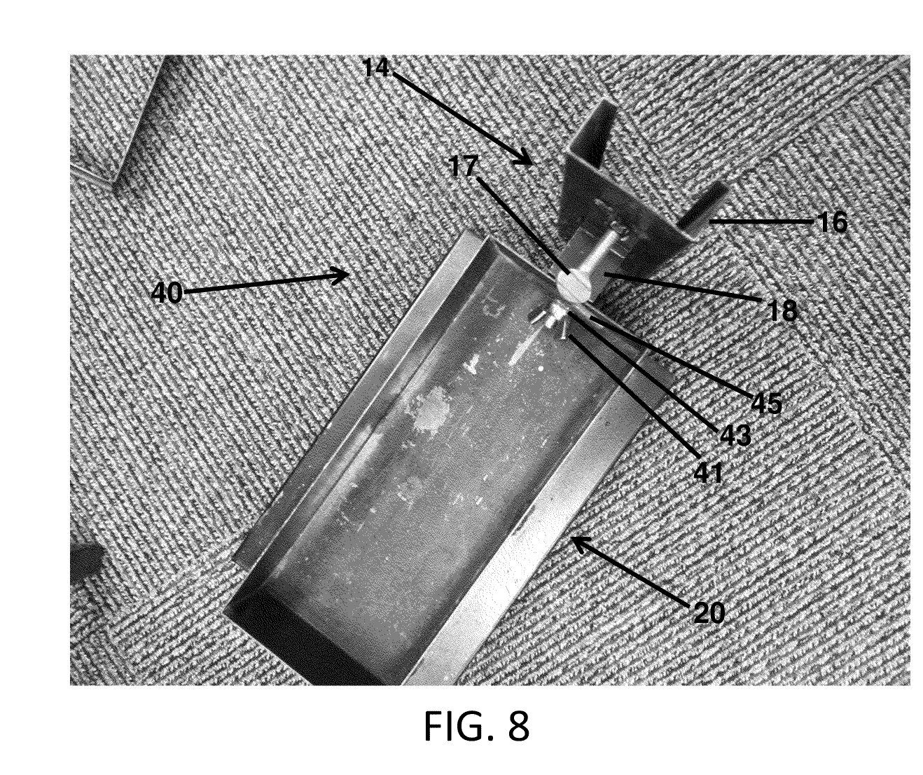

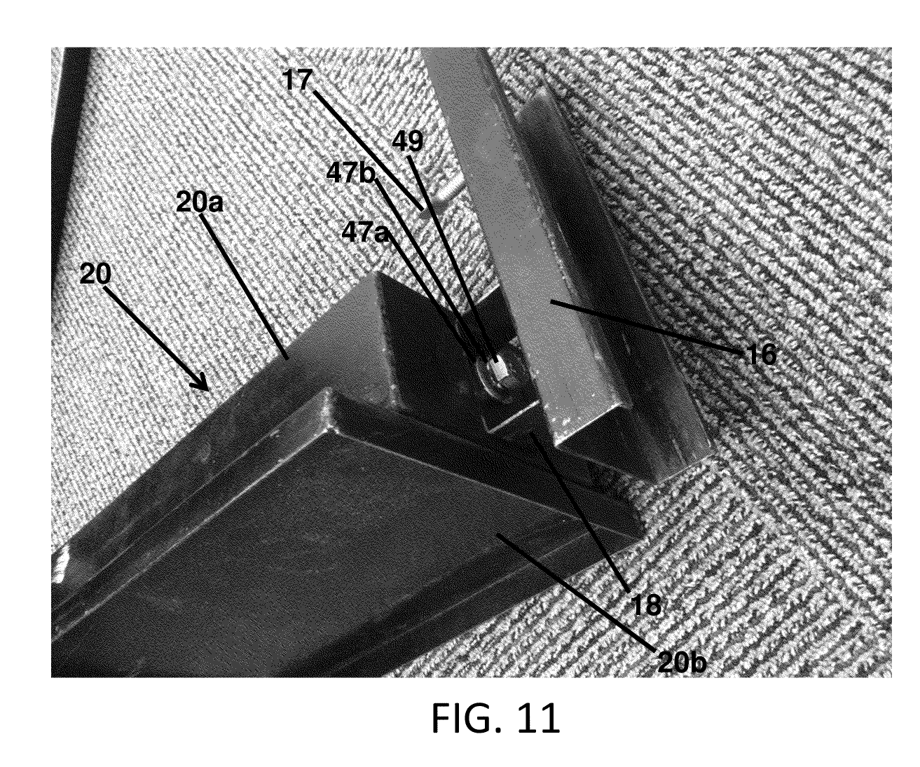

FIGS. 8-11 show an embodiment where frame rail bracket 14 is attached to bottom support member 20 to form the bottom unit 40 of the system. The frame rail bracket 14 is attached to bottom support member 20 by bolt 49 which passes through holes 19 and 23. Bolt 49 is secured by wing nut 41. Support plate 45 and washer 43 intervene between wing nut 41 and side of support member 20. Additionally, washer 47 or washers 47a and 47b intervene between bolt 49 and side of brace 16. Further, FIG. 11 shows bottom support member 20 may be comprised of top box 20a and bottom box 20b joined together. Bottom box 20b may be thinner and wider than top box 20a to provide a ledge for bottom support unit 20.

An additional feature of FIGS. 4-11 is that the bolt and wing nut assembly allows both the bottom support member 20 and top support member 24 to be adjusted at an angle relative to the frame rail bracket 14. This is achieved by loosening the wingnut securing the bolt, positioning the bottom support member 20 and top support member 24 at a desired angle relative to the frame rail bracket 14, and then retightening the bolt and wing nut assembly. Embodiments of the system of the invention allow the top support member or bottom support member to be positioned at a wide variety of angles rotating on an axis provided by the bolt and wing nut assembly, including anywhere from 0° to 20°, 0° to 45°, and 0° to 90°, 0° to 135°, 0° to 180°, 0° to 225°, 0° to 270°, 0° to 315°, and 0° to 360°.

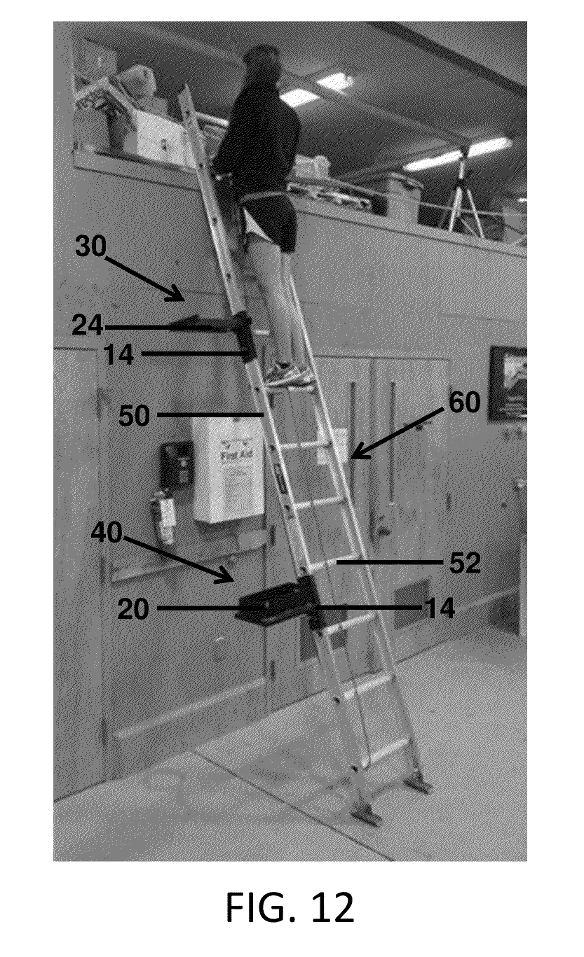

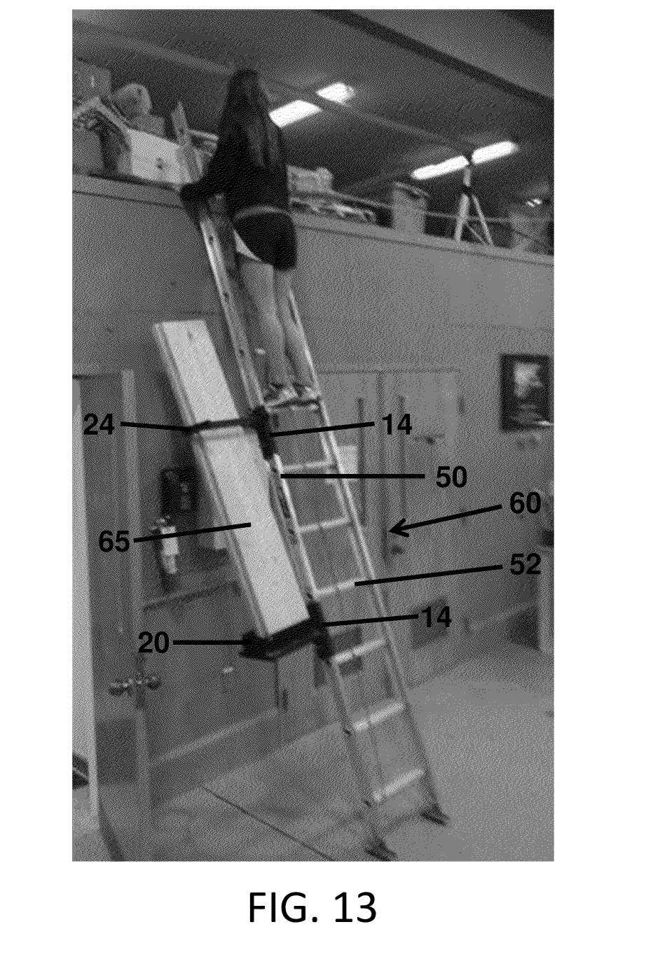

FIGS. 12 and 13 show an embodiment where frame rail bracket 14 is attached to side rail 50 of a ladder 60 to position top unit 30 and bottom unit 40 along the side of ladder 60 in a configuration that allows elongated items 65 to be secured to the ladder 60. FIGS. 12-13 further show that top unit 30 and bottom unit 40 may be attached at any position along side rail 50 irrespective of ladder rungs 52 and that brackets 14 do not interfere or intrude with the climbing surface of the ladder since the brackets are off to the side. Additionally, FIGS. 12 and 13 show that both top 30 and bottom 40 units may be positioned parallel to the ground while ladder 60 is positioned at an angle relative to the vertical wall.

FIG. 13 shows the system of the invention in use for holding elongated items (plywood) 65. As shown in FIG. 13, the system allows for the safe handling of materials 65 by keeping them in reaching distance while simultaneously allowing a worker use of their hands for other activities such as safely climbing up and down the ladder 60.

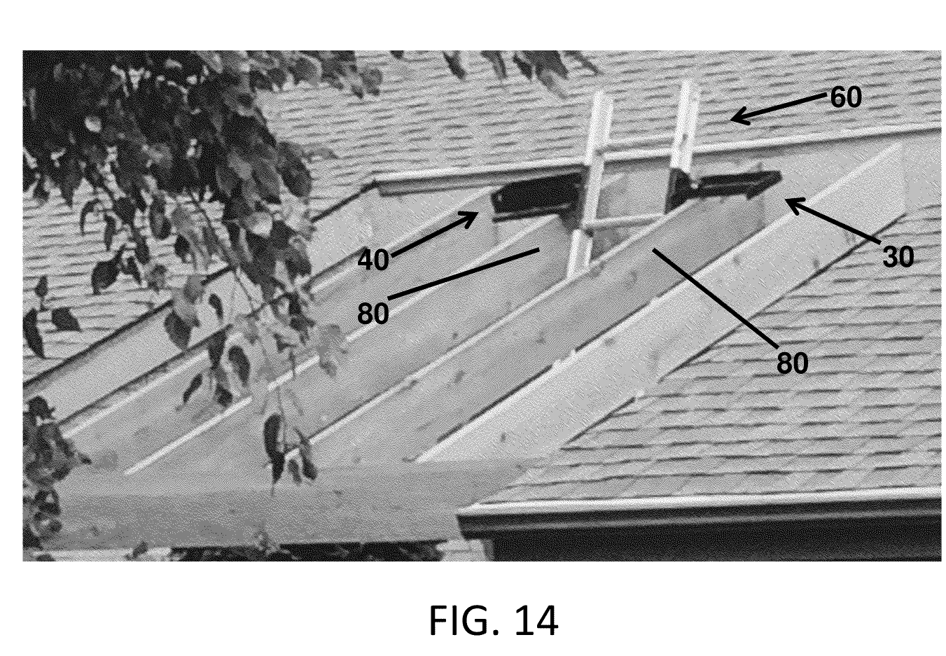

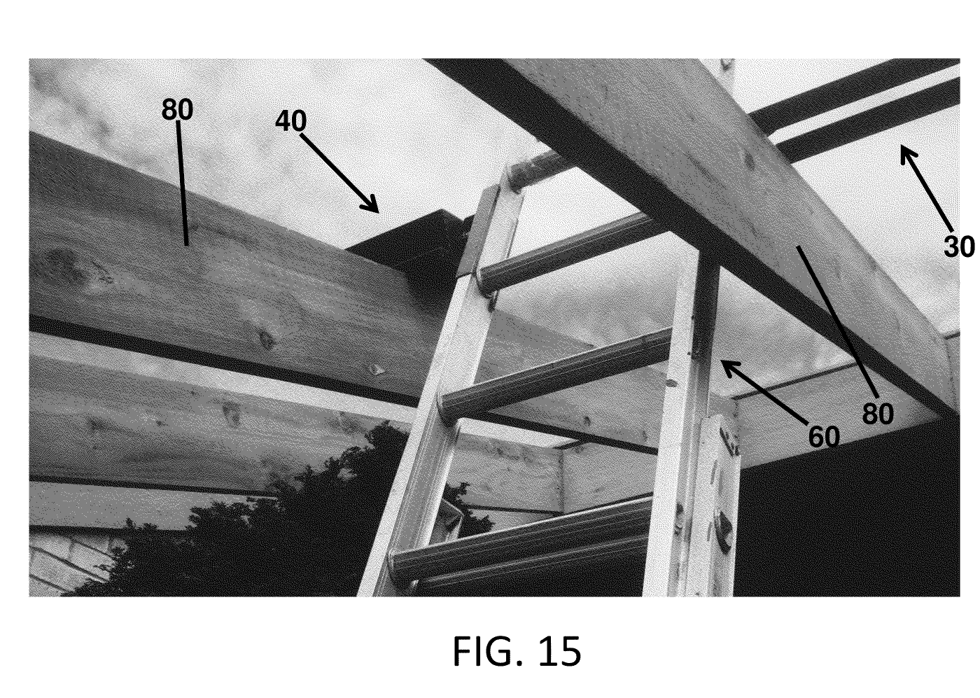

FIGS. 14 and 15 show that the top unit 30 and bottom unit 40 allow a ladder 60 to be placed between two rafters 80 with little pitch when each unit is attached to a ladder 60 and placed on a side and rests on the top chord of a rafter 80. As a worker climbs the ladder 60, the ladder 60 cannot push up the rafter chord, thus allowing a extension ladder 60 to be placed safely and securely along rafters 80.

In one embodiment, the components are constructed from 16-gauge steel. However, in other embodiments the components of the system of the invention may be made of any suitable material, including other stainless steel, aluminum, or plastic, provided that they are carefully tested to ensure structural integrity under anticipated load conditions. For sheet metal components, three dimensional models may be rendered in computer-aided design (CAD) software detailing their specifications, which may be then encoded in instructions to computer numerical control (CNC) machines for fabricating these components from sheet metal. In embodiments, each component can be cut from a single sheet of metal and then cut and folded into the desired configuration. Additionally, plastic components may be manufactured through injection molding or 3-dimensional printing.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A system for securing articles to a ladder, the system comprising:
at least two article support member and frame rail bracket pairs;
wherein each frame rail bracket is configured for slideable engagement with a side rail of a ladder without contact with a rung of the ladder;
wherein each frame rail bracket has a tightening mechanism configured to provide pressure between the frame rail bracket and the side rail of the ladder to fix the frame rail bracket at any of a number of positions on the ladder; and
wherein each article support member is in operable communication with one of the frame rail brackets by way of a fastener that provides an axis of rotation for the article support member to rotate from 0° to 360°.

2. The system of claim 1, wherein the fastener is a bolt and wing nut assembly.

3. The system of claim 1, wherein at least one of the article support members is configured as an open box or bucket.

4. The system of claim 1, wherein at least one of the article support members is configured as a four-sided collar.

5. The system of claim 1, wherein at least one of the article support members is configured as an open box or bucket and at least one of the article support members is configured as a four-sided collar.

6. The system of claim 3, wherein the open box or bucket comprises at least three connecting hole options for communication with the fastener.

7. The system of claim 1, wherein each frame rail bracket has no hooks, clips, springs, extensions, or parts capable of interfering with the ladder rungs during when the frame rail bracket is slid up or down the side rail of the ladder.

8. The system of claim 1, wherein the tightening mechanism is a screw or a spring or a combination of these.

9. The system of claim 1, wherein the frame rail bracket and the article support members are made of steel, aluminum, wood, or plastic.

10. The system of claim 1, comprising three or more article support members.

11. A system for securing articles to a ladder, the system comprising:
at least two article support member and frame rail bracket pairs;
wherein at least one of the article support members is configured as a bucket and at least one of the article support members is configured as a four-sided collar;
wherein each frame rail bracket is configured for slideable engagement with a side rail of a ladder without contact with a rung of the ladder;
wherein each frame rail bracket has a tightening mechanism configured to provide pressure between the frame rail bracket and the side rail of the ladder to fix the frame rail bracket at any of a number of positions on the ladder, such that the bucket is capable of being positioned on the ladder at a position vertically below the collar; and
wherein each article support member is in operable communication with one of the frame rail brackets by way of a fastener that provides an axis of rotation for the article support member to rotate from 0° to 360°.

12. The system of claim 11, wherein the fastener is a bolt and wing nut assembly.

13. The system of claim 12, wherein the bucket comprises at least three connecting hole options for communication with the fastener.

14. The system of claim 11, comprising three or more article support members.

15. The system of claim 14, wherein only one of the article support members is configured as a bucket.

16. An article of manufacture, comprising:
a frame rail bracket configured to wrap around three sides and a portion of a fourth side of a side rail of a ladder and having a tightening mechanism capable of producing pressure between the side rail and the bracket;
wherein the frame rail bracket is capable of sliding along the side rail without interfering with the ladder rungs when repositioned during use.

17. The article of manufacture of claim 16, wherein the frame rail bracket has no hooks, clips, springs, extensions, or other parts which are capable of interfering with the ladder rungs when the frame rail bracket is slid up or down the side rail of the ladder.

18. The article of manufacture of claim 16, further comprising an open box, wherein the frame rail bracket comprises a brace and the open box is operably connected to the frame rail bracket through the brace and one or more fasteners.
